(19) United States
(12) Patent Application Publication
(10) Pub. No.: US 2019/0214172 A1
(43) Pub. Date: Jul. 11, 2019

(54) POWDER FOR MAGNETIC CORE, METHOD OF PRODUCING DUST CORE, DUST CORE, AND METHOD OF PRODUCING POWDER FOR MAGNETIC CORE

(71) Applicant: TOYOTA JIDOSHA KABUSHIKI KAISHA, Toyota-shi (JP)

(72) Inventors: Masashi OHTSUBO, Nagakute-shi (JP); Masaaki TANI, Nagakute-shi (JP); Takeshi HATTORI, Nagakute-shi (JP); Junghwan HWANG, Nagakute-shi (JP); Masashi HARA, Nagakute-shi (JP); Shin TAJIMA, Nagakute-shi (JP); Shinjiro SAIGUSA, Toyota-shi (JP); Kohei ISHII, Nagoya-shi (JP); Daisuke OKAMOTO, Toyota-shi (JP); Toshimitsu TAKAHASHI, Toyota-shi (JP)

(73) Assignee: TOYOTA JIDOSHA KABUSHIKI KAISHA, Toyota-shi (JP)

(21) Appl. No.: 16/356,696

(22) Filed: Mar. 18, 2019

Related U.S. Application Data
(62) Division of application No. 14/847,497, filed on Sep. 8, 2015.

(30) Foreign Application Priority Data
Sep. 8, 2014 (JP) 2014-182730

(51) Int. Cl. H01F 1/33; H01F 41/02; H01F 1/26; B22F 3/02; C21D 1/26; B22F 1/00; B22F 1/02; H01F 1/20; B22F 3/24; C21D 6/00; C22C 38/02; C22C 38/06

(52) U.S. Cl. CPC H01F 1/33; H01F 41/0246; H01F 1/26; B22F 3/02; C21D 1/26; B22F 1/0003; H01F 1/24; H01F 1/20; B22F 3/24; H01F 41/02; C21D 6/008; C22C 38/02; C22C 38/06; B22F 1/02

(57) ABSTRACT

A dust core includes soft magnetic particles, a first coating layer, a second coating layer, and a third coating layer. The first coating layer is made of aluminum oxide with which at least a part of surfaces of the soft magnetic particles are coated. The second coating layer is made of aluminum nitride with which at least a part of a surface of the first coating layer is coated. The third coating layer is made of low-melting-point glass with which at least a part of a surface of the second coating layer is coated. The low-melting-point glass has a softening point lower than an annealing temperature of the soft magnetic particles.

### INCORPORATION BY REFERENCE

The disclosure of Japanese Patent Application No. 2014-182730 filed on Sep. 8, 2014 including the specification, drawings and abstract is incorporated herein by reference in its entirety.

### BACKGROUND OF THE INVENTION

### 1. Field of the Invention

The present invention relates to a dust core which is superior in volume specific resistance (hereinafter, referred to simply as “specific resistance”) and strength, powder for a magnetic core from which the dust core can be obtained, and production methods thereof.

### 2. Description of Related Art

Electromagnetic products, for example, transformers, motors, power generators, speakers, induction heaters, or various actuators are used in the related art. Most of these products use an alternating magnetic field. Typically, in order to efficiently obtain a locally high alternating magnetic field, a magnetic core (soft magnet) is provided in the alternating magnetic field.

The magnetic core is required to provide not only high magnetic characteristics in an alternating magnetic field but also reduced high-frequency wave loss during use in an alternating magnetic field. This high-frequency wave loss may also be referred to as “iron loss” irrespective of the material of a magnetic core. The high-frequency wave loss includes eddy current loss, hysteresis loss, and residual loss. In this case, it is important to decrease eddy current loss which increases along with an increase in the frequency of an alternating magnetic field.

In order to decrease eddy current loss, the development and research of a dust core obtained by press-forming soft magnetic particles (particles constituting powder for a magnetic core) coated with an insulating layer (film) has been done. The insulating layer interposed between the respective soft magnetic particles achieves high specific resistance and reduces high-frequency wave loss of the dust core. The dust core has a high degree of freedom in its shape and is used in various electromagnetic apparatuses. Recently, in order to expand the use of the dust core, further emphasis has been placed on improving specific resistance and strength. Japanese Patent Application Publication No. 2003-243215 (JP 2003-243215 A), Japanese Patent Application Publication No. 2006-233268 (JP 2006-233268 A), and Japanese Patent Application Publication No. 2013-171967 (JP 2013-171967 A) disclose dust cores described below in which specific resistance and strength are improved.

JP 2003-243215 A discloses a dust core including: Fe—Si soft magnetic particles with a surface on which a nitride layer is formed; and an insulating binder (binder) that is made of a silicone resin or the like. This nitride layer is made of silicon nitride and is formed to suppress the diffusion of an insulating material (for example, a silicone resin) to the inside of the soft magnetic particles during high-temperature annealing. The dust core is produced, for example, using a method including: press-forming a compound obtained by kneading Fe-4Si-3Al (wt %) powder and a silicone resin with each other into a compact; and heating the compact in N₂ at 800° C. for 30 minutes to be nitrided and annealed.

However, in the case of the dust core obtained using the above-described method, the annealing temperature is higher than the heat-resistant temperature of the silicone resin or the like which is the insulating material. Therefore, insulating properties and binding strength between the soft magnetic particles are likely to be insufficient. Accordingly, in the method disclosed in JP 2003-243215 A, a homogeneous or uniform nitride layer may not be formed between the soft magnetic particles.

JP 2006-233268 A discloses that magnetic powder including particles with a surface coated with an AlN film having high electrical resistance can be obtained by heating gas-atomized powder (Fe—Cr—Al), which is put into a container made of SUS316, to 1000° C. in air (nitrogen-containing atmosphere). The powder used to form the AlN film contains Cr. When the powder does not contain Cr, iron nitride is produced.

When the Fe—Cr—Al powder is heated in air as described in JP 2006-233268 A, typically, a considerable amount of an oxide (oxide film) is formed on the particle surfaces. Therefore, AlN may be heterogeneously formed on the particle surfaces. JP 2006-233268 A does not make a detailed description of the specific resistance and strength of the dust core.

JP 2013-171967 A discloses that a dust core including particles with a surface on which a nitride is formed can be obtained by microwave-heating a compact made of gas-atomized powder (Fe-6.5 wt % Si), which is insulated using SiO₂, in a nitrogen-containing atmosphere. This nitride is a silicon nitride, not AlN described below. In addition, JP 2013-171967 A does not make a description of low-melting-point glass.

### SUMMARY OF THE INVENTION

The invention provides powder for a magnetic core, a method of producing a dust core, a dust core, and a method of producing powder for a magnetic core.

A powder for a magnetic core according to a first aspect of the invention includes: soft magnetic particles; an oxide layer made of aluminum oxide with which at least a part of surfaces of the soft magnetic particles are coated; and a nitride layer made of aluminum nitride with which at least a part of a surface of the oxide layer is coated.

The powder for a magnetic core according to the first aspect of the invention may further include low-melting-point glass. The low-melting-point glass may be attached to at least a part of the surface of the nitride layer and have a softening point lower than an annealing temperature of the soft magnetic particles.

A method of producing a dust core according to a second aspect of the invention includes: filling a mold with the powder for a magnetic core according to the first aspect of the invention; press-forming the filled powder for a magnetic core into a compact; and annealing the compact.

A dust core according to a third aspect of the invention includes soft magnetic particles, a first coating layer, a second coating layer, and a third coating layer. The first coating layer is made of aluminum oxide with which at least a part of surfaces of the soft magnetic particles are coated. The second coating layer is made of aluminum nitride with which at least a part of a surface of the first coating layer is coated. The third coating layer is made of low-melting-point glass with which at least a part of a surface of the second coating layer is coated. The low-melting-point glass has a softening point lower than an annealing temperature of the soft magnetic particles.

In the third aspect of the invention, the soft magnetic particles may be made of an iron alloy containing Al.

In the above configuration, the iron alloy may further contain Si. A mass ratio of a content of Al to a total content of Al and Si in the iron alloy may be 0.45 or higher.

In the above configuration, the mass ratio of the content of Al may be 0.67 or higher.

In the above configuration, the total content of Al and Si may be 10 mass % or less with respect to 100 mass % of a total mass of the iron alloy.

In the third aspect of the invention, the low-melting-point glass may contain borosilicate glass.

In the third aspect of the invention, a content of the low-melting-point glass may be 0.05 mass % to 4 mass % with respect to 100 mass % of a total mass of the dust core.

In the above configuration, the content of the low-melting-point glass may be 0.1 mass % to 1 mass % with respect to 100 mass % of the total mass of the dust core.

A fourth aspect of the invention is a method of producing powder for a magnetic core. The method includes heating oxide particles including an oxide layer in a nitriding atmosphere in a temperature range of 800° C. to 1050° C. to form a nitride layer made of aluminum nitride on at least a part of a surface of the oxide layer. The oxide particles is made of an iron alloy containing Al. The oxide layer is made of aluminum oxide and provided on at least a part of surfaces of the oxide particles.

In the fourth aspect of the invention, an oxygen concentration in the surfaces of the oxide particles may be 0.08% or higher.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1A is a schematic diagram showing a grain boundary in a dust core according to an embodiment of the invention;

FIG. 1B is a schematic diagram showing a step of forming a nitride layer on an oxide layer according to the embodiment of the invention;

FIG. 2A is an AES graph obtained by observing regions near surfaces of nitride particles (Sample 12)

FIG. 2B is an AES graph obtained by observing regions near surfaces of nitride particles (Sample 19)

FIG. 2C is an AES graph obtained by observing regions near surfaces of nitride particles (Sample 20)

FIG. 3 is an XRD profile showing regions near surfaces of nitride particles (Sample 1);

FIG. 4 is a dispersion diagram showing a relationship between the specific resistance and the radial crushing strength of a dust core according to each sample;

FIG. 5 is a table showing production conditions of a dust core according to each sample and characteristics thereof; and

FIG. 6 is a table showing the compositions and the softening points of low-melting-point glasses shown in FIG. 5.

### DETAILED DESCRIPTION OF EMBODIMENTS

As a result of trial and error, the present inventors found that a dust core having high specific resistance and high strength can be obtained by forming a grain boundary including three layers of an aluminum oxide layer, an aluminum nitride layer, and a low-melting-point glass layer, between soft magnetic particles. Based on this finding, the invention has been made. Hereinafter, the summary of embodiments of the invention will be described.

A dust core according to an embodiment of the invention includes: soft magnetic particles; a first coating layer made of aluminum oxide with which at least a part of surfaces of the soft magnetic particles are coated; a second coating layer made of aluminum nitride with which at least a part of a surface of the first coating layer is coated; and a third coating layer made of low-melting-point glass with which at least a part of a surface of the second coating layer is coated, the low-melting-point glass having a softening point lower than an annealing temperature of the soft magnetic particles.

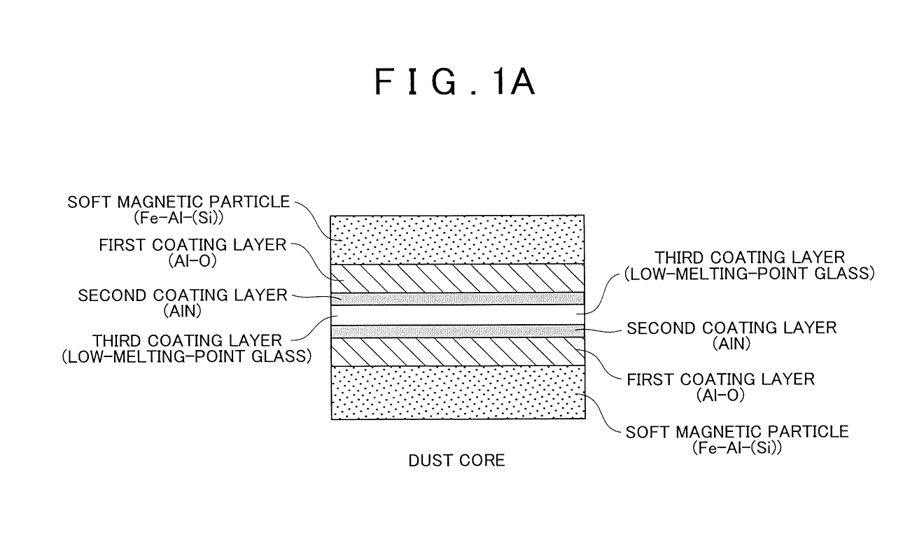

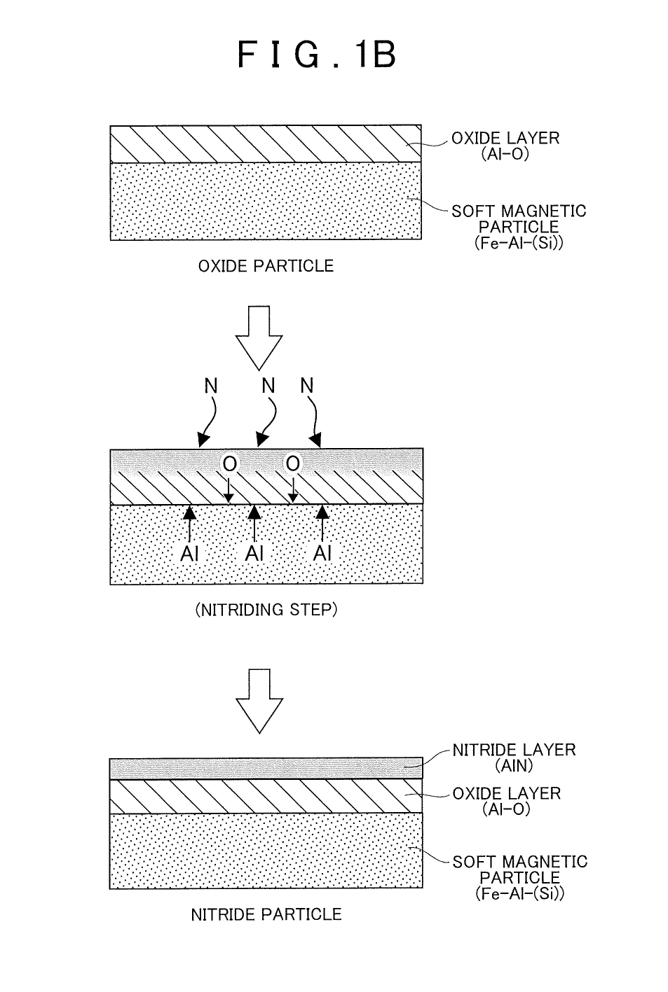

In the dust core according to the embodiment of the invention, a grain boundary between adjacent soft magnetic particles has a three-layer structure including a first coating layer, a second coating layer, and a third coating layer (refer to FIG. 1A). Among these layers, the second coating layer (appropriately referred to as “AlN layer”) made of aluminum nitride that is formed on the first coating layer (appropriately referred to as “Al—O layer”) made of aluminum oxide exhibits high insulating properties without modification or defects even after high-temperature annealing is performed to remove residual strain introduced into the soft magnetic particle during forming. Even when defects such as cracks are formed in the second coating layer, the insulating properties between the soft magnetic particles are maintained by the third coating layer made of low-melting-point glass with which the surface of the second coating layer is coated.

In addition, the low-melting-point glass which is softened or melted during annealing has superior wettability on the AlN layer and wets the AlN layer and is uniformly spread thereon. Therefore, in the dust core according to the embodiment of the invention, small pores (for example, a triple point) between the soft magnetic particles are filled with the low-melting-point glass, and thus substantially no voids which are fracture origins are formed. As a result, the third coating layer (also appropriately referred to as “low-melting-point glass layer”) made of low-melting-point glass improves insulating properties between adjacent soft magnetic particles in conjunction with the second coating layer and can strongly bind the adjacent soft magnetic particles.

The layers constituting the grain boundary act synergistically. As a result, the dust core according to the embodiment of the invention can exhibit high magnetic characteristics (for example, low coercive force and low hysteresis loss) while simultaneously realizing high levels of specific resistance and strength.

In the case of the dust core according to the embodiment of the invention, the diffusion of the respective constituent elements between the low-melting-point glass and the soft magnetic particles is substantially suppressed even after high-temperature annealing although the reason thereof is not clear. It is considered that the suppression of the diffusion of the respective constituent elements is achieved because the compound layers (in particular, the AlN layer) interposed between the low-melting-point glass and the soft magnetic particles function as barrier layers to suppress modification or deterioration of the low-melting-point glass. It is considered that the above effect of the AlN layer contributes to the improvement of the specific resistance and strength of the dust core.

It is considered that the first coating layer (Al—O layer) contributes to the improvement of the specific resistance and strength of the dust core and also significantly contributes to the stable and uniform formation of the second coating layer (AlN layer) as an underlayer.

According to an embodiment of the invention, there may be provided powder for a magnetic core which is suitable to produce the above-described dust core. Specifically, the powder for a magnetic core according to the embodiment of the invention may include: soft magnetic particles; an oxide layer made of aluminum oxide with which at least a part of surfaces of the soft magnetic particles are coated; and a nitride layer is made of aluminum nitride with which at least a part of a surface of the oxide layer is coated. This powder for a magnetic core may be used to produce the above-described dust core. In the powder for a magnetic core, low-melting-point glass having a softening point lower than an annealing temperature of the soft magnetic particles may be attached to the nitride layer.

In this specification, soft magnetic particles including the oxide layer and the nitride layer on surfaces thereof, or soft magnetic particles further including the low-melting-point glass on a surface of the nitride layer will be appropriately referred to as “particles for a magnetic core”. An aggregate of the particles for a magnetic core may be considered as the powder for a magnetic core according to the embodiment of the invention.

The existence form of the low-melting-point glass in the particles for a magnetic core is not limited. For example, the low-melting-point glass may be attached to the particle surfaces in the form of glass fine particles having a particles size less than that of the soft magnetic particles or in the form of a film or a layer. The same shall be applied to a method of producing powder for a magnetic core. When a compact of the powder for a magnetic core is annealed, it is only necessary that the low-melting-point glass is softened or melted such that the third coating layer is formed on the second coating layer.

According to an embodiment of the invention, there may be provided a method of producing the above-described powder for a magnetic core. The method according to the embodiment of the invention includes a nitriding step of heating oxide particles, which are made of an iron alloy containing Al and include an oxide film made of aluminum oxide on at least a part of surfaces of the oxide particles, in a nitriding atmosphere in a temperature range of 800° C. to 1050° C., preferably, 850° C. to 1000° C. to form a nitride layer made of aluminum nitride on at least a part of a surface of the oxide layer. The method according to this embodiment may further include a glass attachment step of attaching low-melting-point glass to a part of the surface of the nitride layer, the low-melting-point glass having a softening point lower than an annealing temperature of the soft magnetic particles.

The above-described oxide particles can be obtained by separately performing an oxidation step of forming an oxide layer on at least a part of surfaces of soft magnetic particle, the oxide layer being made of aluminum oxide, and the soft magnetic particles being made of an iron alloy containing Al. During the production of the soft magnetic particles, the oxide layer may be formed concurrently (naturally). For example, when gas-water atomized powder or water-atomized powder is used, the above-described oxide layer is formed on particle surfaces naturally. Of course, the oxide particles according to the embodiment of the invention can be obtained from gas-atomized powder by adjusting an atmosphere (oxygen concentration) into which molten iron alloy is sprayed. In this case, it is considered that oxygen, which is contained in the atmosphere in which molten iron alloy is sprayed, or water, which is a cooling medium of the sprayed particles, is an oxygen source for forming the oxide layer.

The mechanism of forming the nitride layer, which significantly contributes to the improvement of the specific resistance and strength of the dust core, on the oxide layer is not necessarily clear but, currently, is presumed to be as follows. When the soft magnetic particles (oxide particles), which is made of an iron alloy containing Al and includes the oxide layer on the surfaces of the soft magnetic particles, is heated in a nitriding atmosphere, Al which is more likely to be oxidized than Fe (which has low oxide formation energy) is diffused from the inside of the soft magnetic particles to the surface side thereof which is the oxide layer. Conversely, O present in the oxide layer is diffused to the inside of the soft magnetic particles. Therefore, stable aluminum oxide is more likely to be formed toward the inside of the oxide layer (the surface side of the soft magnetic particles). On the other hand, unstable aluminum oxide (oxygen-deficient aluminum oxide) having a low oxygen concentration is formed toward the outside (the outermost surface side) of the oxide layer. That is, at least on a region near the outermost surface of the oxide layer, unstable aluminum oxide (Al—O) in which O required to form a complete compound is partially deficient may be formed.

When nitrogen (N) heated to a high temperature comes into contact with the outermost surface of the oxide layer in this state, N is likely to be introduced into Al—O in the oxygen-deficient state, and at least a part of Al reacts with N. As a result, it is considered that the nitride layer made of stable AlN is formed on the region near the outermost surface of the oxide layer (refer to FIG. 1A). The nitrided soft magnetic particles (soft magnetic particles including the nitride layer) will be appropriately referred to as “nitride particles”.

It is considered that aluminum nitride constituting the nitride layer is mainly made of AlN, but it may be made of an incomplete nitride in which an atomic ratio of Al to N is not exactly 1:1. In addition, it is considered that the composition and structure of aluminum oxide constituting the oxide layer may vary depending on the thickness positions in the layers or may vary before and after the respective treatments. Therefore, it is difficult to completely specify the composition and structure of aluminum nitride constituting the nitride layer. Examples of aluminum oxide include aluminum oxide (III) represented by α-Al₂O₃ or γ-Al₂O₃; aluminum oxide (I) represented by Al₂O; aluminum oxide (II) represented by AlO; and partially oxygen-deficient aluminum oxide obtained from above examples. Aluminum oxide according to the embodiment of the invention is not limited to one kind of aluminum oxide but may be a mixture of plural kinds of aluminum oxides. In consideration of the step of forming the nitride layer, it is considered to be preferable that the oxide layer before nitriding is obtained from oxygen-deficient aluminum oxide.

According to an embodiment of the invention, there may be provided a method of producing a dust core. The method according to the embodiment includes: a filling step of filling a mold with the above-described powder for a magnetic core; a forming step of press-forming the powder for a magnetic core in the mold into a compact; and an annealing step of annealing the compact obtained after the forming step. According to this method, a dust core having superior specific resistance and strength can be obtained.

It is preferable that each of the layers according to each of the embodiments of the invention is uniformly or homogeneously formed on the particle surfaces. However, each of the layers may have a non-coated portion or a non-uniform or heterogeneous portion. In addition, the composition or state (for example, composition distribution) of each of the layers may vary during steps ranging from the formation of each of the layers to the annealing of the dust core.

“The annealing temperature of the soft magnetic particles” according to each of the embodiments of the invention refers to, specifically, the heating temperature of the annealing step which is performed to remove residual strain or residual stress from the press-formed compact of the powder for a magnetic core. The specific temperature of the annealing temperature is not particularly limited as long as it is higher than the softening point of the selected low-melting-point glass. For example, the annealing temperature is preferably 650° C. or higher, more preferably 700° C. or higher, still more preferably 800° C. or higher, and even still more preferably 850° C. or higher.

“The softening point” described in each of the embodiments of the invention refers to a temperature at which the viscosity of the heated low-melting-point glass is 1.0×10^{7.5} dPa·s. Accordingly, the softening point described in each of the embodiments of the invention does not necessarily match a so-called glass transition point (Tg). The softening point of glass is specified using “Viscosity and viscometric fixed points of glass-Part 1: Determination of softening point” according to JIS R 3103-1.

Unless specified otherwise, “x to y” described in this specification includes a lower limit x and an upper limit y. Various numerical values described in this specification and numerical values included in the numerical value ranges can be appropriately combined to configure a new numerical value range such as “a to b”.

Hereinafter, the embodiments of the invention will be described in detail.

The soft magnetic particles are not particularly limited as long as they contain a ferromagnetic element such as a Group 8 transition element (for example, Fe, CN, or Ni) as a major component. However, the soft magnetic particles are preferably made of pure iron or an iron alloy from the viewpoints of handleability, availability, cost, and the like. It is preferable that the iron alloy is an iron alloy containing Al (Al-containing iron alloy) because the oxide layer (or the first coating layer) made of aluminum oxide and the nitride layer (or the second coating layer) made of aluminum nitride are easily formed. Further, it is preferable that the iron alloy contains Si because the improvement of the electric resistivity of the soft magnetic particles, the improvement of the specific resistance of the dust core (reduction in eddy current loss), the improvement of the strength, or the like is realized. It is also preferable that the iron alloy further contains Si in combination with Al because the oxide layer and the nitride layer are easily formed. Unless specified otherwise, the description of the specification relating to the oxide layer or the nitride layer can be appropriately applied to the first coating layer or the second coating layer.

It is not preferable that the Si content the iron alloy described in the embodiment of the invention is excessively high because a silicon compound (silicon oxide: SiO₂ or silicon nitride: Si₃N₄) is likely to be preferentially formed on the surfaces of the soft magnetic particles. Therefore, in the iron alloy according to the embodiment of the invention, an Al ratio (Al/Al+Si) which is a mass ratio of the Al content to the total content (Al+Si) of Al and Si is preferably 0.447 or higher, 0.45 or higher, more preferably 0.6 or higher, still more preferably 0.67 or higher, 0.7 or higher, and even still more preferably 0.8 or higher. The upper limit of the Al ratio is preferably 1 or lower and more preferably 0.96 or lower. At this time, the total content of Al and Si is preferably 10% or less, more preferably 6% or less, and still more preferably 5% or less with respect to 100 mass % (hereinafter, simply referred to as “%”) of the total mass of the iron alloy. The lower limit of the total content of Al and Si is preferably 2% or higher and more preferably 3% or higher.

The specific composition of Al or Si in the iron alloy can be appropriately adjusted in consideration of, for example, the formability of the oxide layer and the nitride layer, the magnetic characteristics of the dust core, and the press-formability of the powder for a magnetic core. For example, with respect to 100% of the total mass of the iron alloy constituting the soft magnetic particles, the Al content is preferably 0.01% to 7%, more preferably 1% to 6%, and still more preferably 2% to 5%, and the Si content is preferably 0.5% to 4%, more preferably 1% to 3%, and still more preferably 1.5% to 2.5%. It is not preferable that the Al content or the Si content is excessively low because the above-described effects are poor. It is not preferable that the Al content or the Si content is excessively high because, for example, the magnetic characteristics and press-formability of the dust core decrease and the cost increases.

In the iron alloy according to the embodiment of the invention, a remainder contains Fe as a major component. In addition to Fe and unavoidable impurities, the remainder may further contain one or more modifying elements which can improve the formability of AlN, the magnetic characteristics and specific resistance of the dust core, and the press-formability of the powder for a magnetic core. As the modifying elements, for example, Mn, Mo, Ti, Ni, or Cr may be considered. Typically, the amount of the modifying element is very small, and the content thereof is preferably 2% or lower and more preferably 1% or lower.

The particle size of the soft magnetic particles is not particularly limited. Typically, the particle size is preferably 10 μm to 300 μm and more preferably 50 μm to 250 μm. It is not preferable that the particle size is excessively large because a decrease in specific resistance or an increase in eddy current loss is caused. It is not preferable that the particle size is excessively small because, for example, an increase in hysteresis loss is caused. Unless specified otherwise, the particle size of the powder described in this specification is defined as the particle size of the powder after being classified using a sieving method with a sieve having a predetermined mesh size.

Regarding base particles for obtaining the soft magnetic particles or base powder which is an aggregate of the base particles, a production method thereof is not limited as long as the dust core according to the embodiment of the invention can be obtained. Further, it is preferable that an appropriate amount of oxygen is present on surfaces of the base particles before coating such that the Al—O layer functioning as the first coating layer is stably formed on the surfaces of the soft magnetic particles. For example, the oxygen concentration in the surfaces of the base particles is preferably 0.08% or higher, more preferably 0.1% or higher, and still more preferably 0.17% or higher. The oxygen concentration described in this specification is specified using the following method, and the total mass of the base powder before coating (the total mass of the base particles which are measurement objects) is defined as 100 mass %.

The oxygen concentration described in this specification is defined using an infrared absorbing method (infrared spectroscopy: IR). Specifically, base particles (a part of the base powder) which are samples of the measurement objects are heated and melted in an inert gas (He) atmosphere to produce CO. The produced Co is extracted and detected by a detector for quantification. As a result, the oxygen concentration is specified.

It is preferable that the base powder (oxide powder) is made of oxide particles in which an oxide layer made of oxygen-deficient aluminum oxide is formed on surfaces of the oxide particles. It is preferable that the base powder is made of pseudo-spherical particles, aggressiveness between the particles decreases, and a decrease in specific resistance is suppressed. As the base powder (oxide powder), for example, gas-water atomized powder is preferable. The base powder may be made of a single kind of powder or may be made of a mixture of plural kinds of powders having different particle sizes, production methods, and compositions.

As the low-melting-point glass according to the embodiment of the invention, low-melting-point glass having an appropriate composition is preferably selected in consideration of the specific resistance, strength, annealing temperature, and the like required in the dust core. As the low-melting-point glass according to the embodiment of the invention, low-melting-point glass having lower environmental load than lead borosilicate glass is preferable, and examples thereof include silicate glass, borate glass, borosilicate glass, vanadium oxide glass, and phosphate glass.

More specifically, examples of the silicate glass include glass containing SiO₂—ZnO, SiO₂—Li₂O, SiO₂—Na₂O, SiO₂—CaO, SiO₂—MgO, or SiO₂—Al₂O₃ as a major component. Examples of the bismuth silicate glass include glass containing SiO₂—Bi₂O₃—ZnO, SiO₂—Bi₂O₃—Li₂O, SiO₂—Bi₂O₃—Na₂O, or SiO₂—Bi₂O₃—CaO as a major component. Examples of the borate glass include glass containing B₂O₃—ZnO, B₂O₃—Li₂O, B₂O₃—Na₂O, B₂O₃—CaO, B₂O₃—MgO, or B₂O₃—Al₂O₃ as a major component. Examples of the borosilicate glass include glass containing SiO₂—B₂O₃—ZnO, SiO₂—B₂O₃—Li₂O, SiO₂—B₂O₃—Na₂O, or SiO₂—B₂O₃—CaO as a major component. Examples of the vanadium oxide glass include glass containing V₂O₅—B₂O₃, V₂O₅—B₂O₃—SiO₂, V₂O₅—P₂O₅, or V₂O₅—B₂O₃—P₂O₅ as a major component. Examples of the phosphate include glass containing P₂O₅—Li₂O, P₂O₅—Na₂O, P₂O₅—CaO, P₂O₅—MgO, or P₂O₅—Al₂O₃ as a major component. In addition to the above-described elements, the low-melting-point glass according to the embodiment of the invention may further contain one or more elements of SiO₂, ZnO, Na₂O, B₂O₃, Li₂O, SnO, BaO, CaO, and Al₂O₃.

The content of the low-melting-point glass is preferably 0.05 mass % to 4 mass %, more preferably 0.1 mass % to 2 mass %, and still more preferably 0.5 mass % to 1.5 mass % with respect to 100 mass % of the total mass of the powder for a magnetic core, or is preferably 0.1 mass % 1 mass % with respect to 100 mass % of the total mass of the dust core. When the content of the low-melting-point glass is excessively low, a sufficient amount of the third coating layer cannot be formed, and a dust core having high specific resistance and high strength cannot be obtained. On the other hand, when the content of low-melting-point glass is excessively high, the magnetic characteristics of the dust core may decrease.

However, when the low-melting-point glass (before annealing) in the powder for a magnetic core is in the form of glass fine particles having a particles size less than that of the soft magnetic particle, the particle size of the glass fine particles is preferably 0.1 μm to 100 μm and more preferably 0.5 μm to 50 μm although it depends on the particle size of the soft magnetic particles. When the particle size of the glass fine particles is excessively small, it is difficult to produce or handle the glass fine particles. When the particle size of the glass fine particles is excessively large, it is difficult to uniformly form the third coating layer. Examples of a method of specifying the particle size of the glass fine particles include a wet method, a dry method, a method of obtaining the particle size based on a scattering pattern of irradiated laser light, a method of obtaining the particle size based on a difference in sedimentation rate, and a method of obtaining the particle size based on image analysis. In this specification, the particle size of the glass fine particles is specified by image analysis using a scanning electron microscope (SEM).

FIG. 1B is a schematic diagram showing a step of forming the nitride layer on the oxide layer according to the embodiment of the invention. The nitriding step is a step of obtaining particles (nitride particles) for forming the nitride layer made of aluminum nitride on the surfaces of the oxide particles. Various methods of forming the oxide layer may be considered. However, as described above, oxide particles, which are made of an iron alloy containing Al and include an oxide film made of aluminum oxide on at least a part of surfaces of the oxide particles, are heated in a nitriding atmosphere in a temperature range of 800° C. to 1050° C., preferably 820° C. to 1000° C., and more preferably 850° C. to 950° C. As a result, the nitride layer can be uniformly formed the surfaces of the oxide particles. The obtained nitride layer is thin and has high insulating properties and superior wettability on the low-melting-point glass. When the nitriding temperature is excessively high or excessively low, it is difficult to form the nitride layer.

Although various nitriding atmospheres can be considered, the nitriding atmosphere is preferably a nitrogen (N₂) atmosphere. The nitrogen atmosphere may be a pure nitrogen gas atmosphere or a mixed gas atmosphere of nitrogen gas and inert gas (for example, N₂ or Ar). Further, the nitriding atmosphere may be, for example, ammonia gas (NH₃). In order to fix the nitrogen concentration during nitriding to a certain value, the nitriding atmosphere is preferably a flowing atmosphere. Although it depends on the nitrogen concentration in the nitriding atmosphere and the heating temperature, the heating time is, for example, preferably 0.5 hours to 10 hours and more preferably 1 hour to 3 hours. At this time, the oxygen concentration in the nitriding atmosphere is preferably 0.1 vol % or lower.

The glass attachment step is a step of attaching the low-melting-point glass to the surfaces of the nitride particles. For example, when fine particles (glass fine particles) made of the low-melting-point glass are attached to the surfaces of the nitride particles, the glass attachment step may be performed using a wet method or a dry method. For example, when the wet method is used, the glass attachment step may be a wet attachment step of mixing the glass fine particles and the nitride particles with each other in a dispersion medium and then drying the obtained dispersion. When the dry method is used, the glass attachment step may be a dry attachment step of mixing the glass fine particles and the nitride particles with each other without using a dispersion medium. When the wet method is used, the glass fine particles are likely to be uniformly attached to the surfaces of the nitride particles. The dry method is efficient from the viewpoints that the drying step can be omitted. In order to promote the attachment of the glass fine particles, a binder (for example, a binder made of PVA or PVB) may be used. Whether to use the wet method or the dry method is not particularly limited as long as the low-melting-point glass is softened or melted to wet the particle surfaces and to be uniformly spread thereon during the annealing of a compact of the powder for a magnetic core (in this specification, this compact is also referred to as “dust core”).

The dust core according to the embodiment of the invention can be obtained through the following steps including: a filling step of filling a mold having a predetermined-shaped cavity with powder for a magnetic core; a press-forming step of press-forming the powder for a magnetic core into a compact; and an annealing step of annealing the compact. Here, the press-forming step and the annealing step will be described.

A press-forming pressure applied to the soft magnetic powder in the press-forming step is not particularly limited. As the press-forming pressure increases, a dust core having higher density and higher magnetic flux density can be obtained. Examples of such a high-pressure forming method include a warm high-pressure forming method with a lubricated mold. The warm high-pressure forming method with a lubricated mold includes: a filling step of filling a mold, whose inner surface is coated with a higher fatty acid lubricant, with powder for a magnetic core; and a warm high-pressure forming step of press-forming the powder for a magnetic core at a press-forming temperature and a press-forming pressure into a compact such that a metallic soap film is formed between the powder for a magnetic core and the inner surface of the mold separately from the higher fatty acid lubricant.

Here, the term “warm” implies that the press-forming temperature is, for example, preferably 70° C. to 200° C. and more preferably 100° C. to 180° C. in consideration of the effects on the surface film (or the insulating film), the modification of the higher fatty acid lubricant, or the like. The details of the warm high-pressure forming method with a lubricated mold are described in many publications such as Japanese Patent No. 3309970 and Japanese Patent No. 4024705. According to the warm high-pressure forming method with a lubricated mold, ultra-high-pressure forming can be performed while increasing the mold life, and a dust core having high density can be easily obtained.

The annealing step is performed to reduce residual strain or residual stress introduced into the soft magnetic particles during the press-forming step such that the coercive force or hysteresis loss of the dust core can be decreased. At this time, the annealing temperature can be appropriately selected according to the kinds of the soft magnetic particles and the low-melting-point glass and is preferably 650° C. or higher, more preferably 700° C. or higher, still more preferably 800° C. or higher, and even still more preferably 850° C. or higher. The insulating layer (in particular, the nitride layer or the second coating layer) according to the embodiment of the invention has superior heat resistance. Therefore, even after high-temperature annealing, high insulating properties and high barrier performance can be maintained. The annealing temperature is preferably 1000° C. or lower, more preferably 970° C. or lower, and still more preferably 920° C. or lower because excessive heating is unnecessary and the characteristics of the dust core may decrease. The heating time is, for example, preferably 0.1 hours to 5 hours and more preferably 0.5 hours to 2 hours. The heating atmosphere is preferably an inert atmosphere (including a nitrogen atmosphere).

The thickness (film thickness) of each of the coating layers of the dust core according to the embodiment of the invention can be appropriately adjusted. When the thickness of each of the coating layers is excessively small, the specific resistance and strength of the dust core cannot be sufficiently improved. When the thickness of each of the coating layers is excessively large, the magnetic characteristics of the dust core decrease significantly.

The thickness of the first coating layer (oxide layer) is, for example, preferably 0.01 μm to 1 μm and more preferably 0.2 μm to 0.5 μm. The thickness of the second coating layer (nitride layer) is, for example, preferably 0.05 μm to 2 μm and more preferably 0.5 μm to 1 μm. The thickness of the third coating layer is, for example, preferably 0.5 μm to 10 μm and more preferably 1 μm to 5 μm. It is ideal that each of the layers (coating layers) is formed on each particle. However, each of the layers may be partially formed on an aggregate of plural particles.

In the dust core according to the embodiment of the invention, specific characteristics thereof are not particularly limited. However, for example, it is preferable that a density ratio (ρ/ρ₀), which is a ratio of the bulk density (ρ) of the dust core to the true density (ρ₀) of the soft magnetic particles, is preferably 85% or higher, more preferably 90% or higher, and still more preferably 95% or higher because high magnetic characteristics can be obtained.

The specific resistance of the dust core is a value intrinsic to each dust core which does not depend on the shape. For example, the specific resistance is preferably 10² μΩ·m or higher, more preferably 10³ μΩ·m or higher, still more preferably 10⁴ μΩ·m or higher, and even still more preferably 10⁵ μΩ·m or higher. As the strength of the dust core increases, the use thereof expands, which is preferable. The radial crushing strength of the dust core is, for example, preferably 50 MPa or higher, more preferably 80 MPa or higher, and still more preferably 100 MPa or higher.

In the dust core according to the embodiment of the invention, the form thereof is not particularly limited. For example, the dust core can be used in various electromagnetic apparatuses such as motors, actuators, transformers, induction heaters, speakers, or reactors. Specifically, the dust core is preferably used as an iron core constituting a field magnet or an armature of a motor or a power generator. Among these, the dust core according to the embodiment of the invention is suitable for an iron core for a drive motor in which reduced loss and high output (high magnetic flux density) are required. The drive motor is used for an automobile or the like.

Aluminum nitride (second coating layer) according to the embodiment of the invention has high thermal conductivity and superior heat dissipation. Therefore, when the dust core according to the embodiment of the invention is used, for example, as an iron core for a motor, heat generated by eddy current or the like from a coil, which is provided in or around the iron core, is easily dissipated by being conducted to the outside.

Hereinafter, Example 1 of the invention will be described. Various powders for a magnetic core were produced while changing base powder (soft magnetic powder) and nitriding conditions (temperatures) of the base powder. A region near the surface of each of the obtained powder particles was observed by Auger electron spectroscopy (AES) or X-ray diffraction (XRD). Hereinafter, the details will be specifically described.

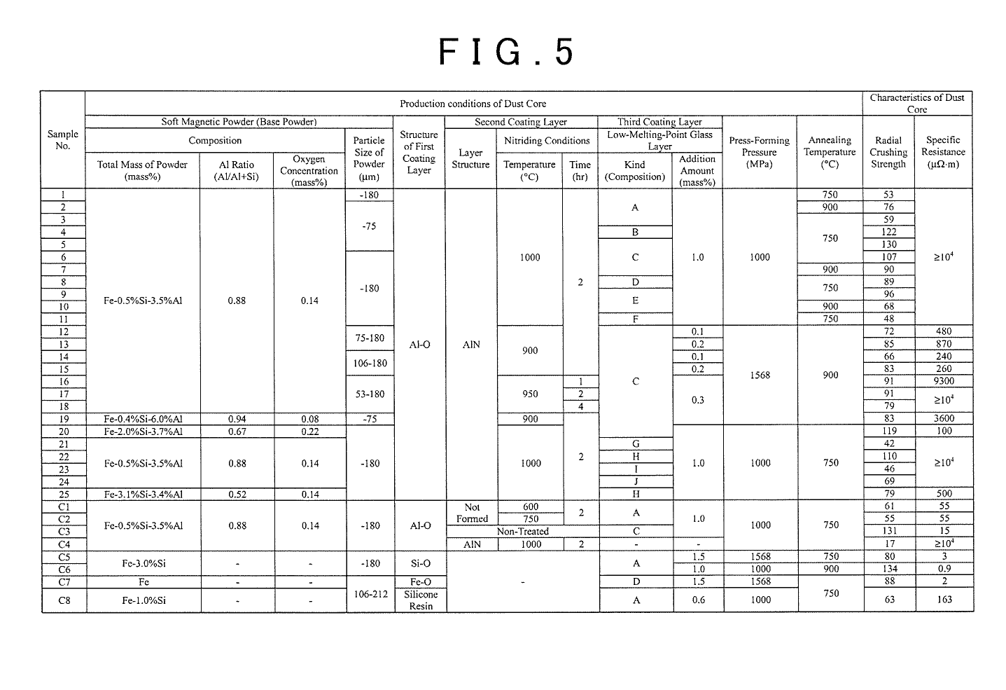

Hereinafter, the production of samples will be described. As base powders including oxide particles, gas-water atomized powders, which were made of five kinds of Fe—Si—Al iron alloys having different formulations as shown in FIG. 5, were prepared. These gas-water atomized powders were produced by spraying molten raw materials into a nitrogen gas atmosphere using nitrogen gas and cooling the sprayed raw materials with water.

As base powders of comparative samples, gas-water atomized powders, which were made of two kinds of Fe—Si iron alloys having different formulations as shown in FIG. 5, and gas-atomized powder made of pure iron were prepared. The gas-water atomized powders made of the Fe—Si iron alloys were produced using the same method as that of the gas-water atomized powder made of the Fe—Si—Al iron alloys. On the other hand, the gas-atomized powder made of pure iron was produced by spraying molten raw materials into a nitrogen gas atmosphere using nitrogen gas and cooling the sprayed raw materials in the nitrogen gas atmosphere. The oxygen concentrations in the respective gas-water atomized powders are collectively shown in FIG. 5. A method of specifying the oxygen concentration was as described above.

The respective base powders were classified with a sieve having a predetermined mesh size using an electromagnetic sieve shaker (manufactured by Retsch). The particle sizes of the respective base powders are collectively shown in FIG. 5. The particle size “x-y” of the powder described in the specification implies that the base powder includes soft magnetic particles which cannot pass through a sieve having a mesh size of x (μm) and can pass through a sieve having a mesh size of y (μm). The particle size “−y” of the powder implies that the base powder includes soft magnetic particles which can pass through a sieve having a mesh size of y (μm). It was verified by an SEM that all the base powders did not contain soft magnetic particles having a particle size of less than 5 μm (hereinafter, the same shall be applied).

Hereinafter, the nitriding step (nitride layer forming step) will be described. Each of the base powders was put into a heat treatment furnace and was nitrided (heated) under conditions shown in FIG. 5 in a nitriding atmosphere in which nitrogen gas (N₂) flowed at a rate of 0.5 L/min. As a result, nitride powders were obtained (Samples 1 to 25, C1, C2, and C4).

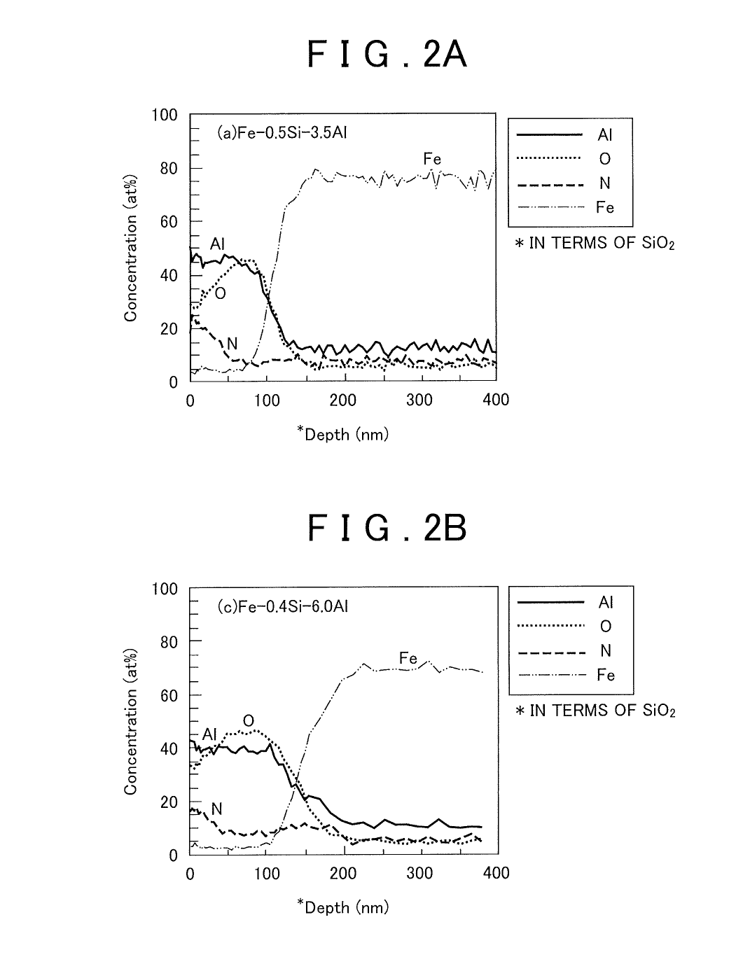

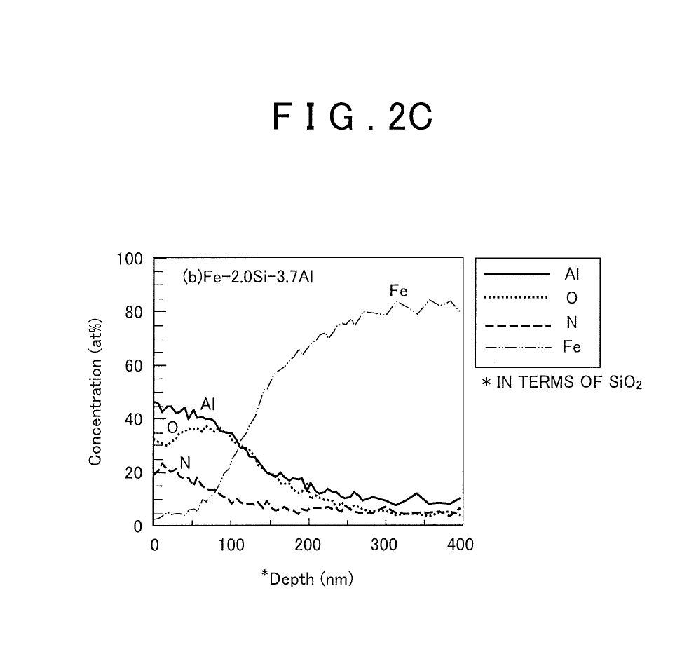

Regarding nitride particles which were arbitrarily extracted from each of the nitride powders according to Samples 12, 19, and 20 having different compositions, Auger electron spectroscopy was performed to investigate the component composition in a region near the surface of each particle (range from the outermost surface to a depth of 600 nm). The results obtained as above are shown in FIGS. 2A to 2C (these drawings will be collectively referred to as “FIG. 2”).

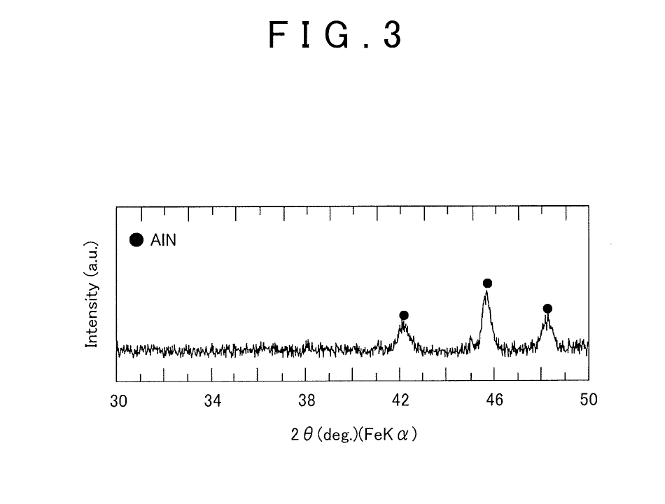

A region near the surface of each of the powder particles arbitrarily extracted from Sample 1 was analyzed by X-ray diffraction (XRD) to obtain a profile, and the obtained profile is shown in FIG. 3. The XRD was performed using an X-ray diffractometer (D8 ADVANCE, manufactured by Bruker AXS) under the conditions of vacuum tube: Fe-Kα, 2θ: 40 deg. to 50 deg., and the measurement conditions: 0.021 deg/step and 9 step/sec.

As can be seen from the respective analysis results shown in FIG. 2, Al, O, and N were mainly distributed in regions (depth: about 50 nm to 100 nm) near the surfaces of the nitride particles. In a region ranging from the outermost surface to a depth (layer depth) of about 50 nm, the N concentration is relatively high. As the depth increases, the N concentration decreased and the O concentration increased. It was found from the above results that an oxide layer made of aluminum oxide having a thickness of about 100 nm to 150 nm was formed on the surfaces of the soft magnetic particles, and a nitride layer made of aluminum nitride having a thickness of about 50 nm to 100 nm was formed on the outermost surface side of the oxide layer.

As clearly seen from a diffraction peak of each X-ray shown in FIG. 3, it was found that the nitride layer was mainly made of AlN. It can be considered from the respective analysis results shown in FIG. 2 that the oxide layer as an underlayer was made of oxygen-deficient aluminum oxide.

As a result of X-ray diffraction on the powder particles according to Sample C2, a diffraction peak derived from AlN was not able to be verified, and the formation of the nitride layer was not able to be observed. The reason is presumed to be that the nitriding temperature was low. From the above results, the following was clarified: in order to stably form the nitride layer in nitrogen gas, it is necessary to perform heat at a relatively high temperature of preferably 800° C. or higher and more preferably 850° C. or higher.

Soft magnetic powder containing Fe-1.6% Si-1.3% Al (Al ratio: 0.45, particle size: 180 μm or less) and soft magnetic powder containing Fe-0.7% Si-1.1% Al (Al ratio: 0.61, particle size: 180 μm or less) were nitrided at 900° C. for 2 hours to prepare nitride powders. Using these nitride powders, X-ray diffraction was performed with the same method as that of the powder particles according to Sample 1. In powder particles of all the soft magnetic powders, a diffraction peak derived from AlN was observed.

Soft magnetic powder containing Fe-6.0% Si-1.6% Al (Al ratio: 0.21, particle size: 106 μm to 212 μm) was nitrided as described above to obtain powder particles. When the same X-ray diffraction was performed using the obtained powder particles, a diffraction peak derived from AlN was not observed. From the above results, the following was clarified: in order to form the nitride layer, it is necessary that the Al ratio is a predetermined value or higher (or is higher than a predetermined value).

A dust core of Example 2 will be described below. In this example, various dust cores were produced using the respective powders shown in FIG. 5, and the specific resistances and radial crushing strengths thereof were measured and evaluated. Hereinafter, the details will be specifically described.

Hereinafter, the production of powder for a magnetic core will be described. The base powders were nitrided as described above to prepare various nitride powders (for example, Samples 1 to 25). For comparison, non-treated base powder (Sample C3) on which the above-described nitriding treatment was not performed, oxidized powders (Samples C5 to C7), and powder (Sample C8) whose particle surfaces were coated with a silicone resin were prepared.

An oxidizing treatment (Samples C5 and C6) of forming an insulating layer made of silicon oxide on surfaces of soft magnetic particles was performed by heating base powder at 900° C. for 3 hours in a hydrogen atmosphere in which the oxygen potential was adjusted. An oxidizing treatment (Sample C7) of forming an insulating layer made of iron oxide on surfaces of soft magnetic particles was performed by heating base powder at 750° C. for 1 hour in a nitrogen atmosphere having an oxygen concentration of 10 vol %. The coating of the silicone resin was performed by putting base powder into a coating resin solution in which 0.2 mass % of a commercially available silicone resin (“YR3370”, manufactured by MOMENTIVE) with respect to the mass of the base powder, volatilizing ethanol, and then curing the silicone resin at 250° C.

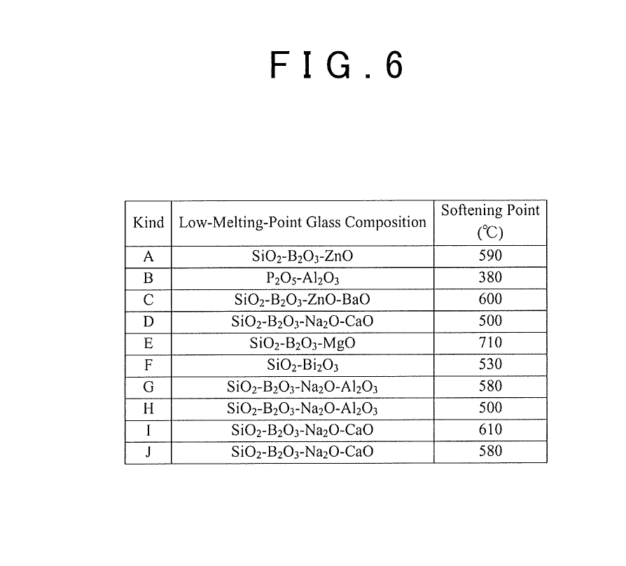

Hereinafter, the glass attachment step will be sequentially described. Powders for a magnetic core were produced by attaching low-melting-point glass to the above-described powder particles of all the samples other than Sample C4. The kinds of the low-melting-point glasses shown in FIG. 5 are any of those shown in FIG. 6. FIG. 6 shows not only the component compositions of the respective low-melting-point glasses but also the softening points thereof described in the specification.

Hereinafter, the preparation of the glass fine particles will be described. As the low-melting-point glasses, commercially available glass flits (B: manufactured by Chiyoda Chemical Co., Ltd. D: manufactured by Tokan Material Technology Co., Ltd., Others: manufactured by Nihon Horo Yuyaku Co., Ltd.) having the respective compositions shown in FIG. 6 were prepared. Each of the glass fits was put into a chamber of a wet grinding mill (dyno mill: manufactured by Shimaru Enterprises Corporation), a stirring propeller was operated, and the glass frit was pulverized. The pulverized glass frit was collected and dried. As a result, glass fine particles made of various kinds of low-melting-point glasses were obtained. The particle size of the obtained glass fine particles was lower than that of the soft magnetic particles, and the maximum particle size was about 5 μm. This particle size was determined by image analysis using a scanning electron microscope (SEM).

Hereinafter, dry coating will be described. The powder of each of the samples and the powder of the glass fine particles were stirred with a rotary ball mill. After stirring, the solidified powders were crushed with a mortar. As a result, powder for a magnetic core including particles with a surface to which the glass fine particles were attached was obtained. The addition amount of the low-melting-point glass (the powder of the glass fine particles) with respect to 100 mass % of the addition amount of the powder for a magnetic core is shown in FIG. 5.

Hereinafter, the production of a dust core will be described. First, the pressure-forming step will be described. Using each of the powders for a magnetic core, a compact having an annular shape (outer diameter: φ39 mm×inner diameter: φ30 mm×height: 5 mm) was obtained with a warm high-pressure forming method with a lubricated mold. At this time, for example, an internal lubricant or a resin binder was not used at all. Specifically, each of the powders was press-formed as described below.

A cemented carbide mold having a cavity corresponding to a desired shape was prepared. This mold was heated to 130° C. using a band heater in advance. An inner peripheral surface of the mold was coated with TiN in advance, and the surface roughness thereof was 0.4 Z.

The inner peripheral surface of the heated mold was uniformly coated with an aqueous dispersion containing lithium stearate (1%) using a spray gun at a rate of about 10 cm³/min. This aqueous dispersion was obtained by adding a surfactant and a defoaming agent to water. The details of the other configurations are described in Japanese Patent No. 3309970 and Japanese Patent No. 4024705.

A mold, whose inner surface was coated with lithium stearate, was filled with each of the powders for a magnetic core (filling step), and the mold was press-formed in a warm environment at 1000 MPa or 1568 MPa while holding the mold at 130° C. (press-forming step). During this warm press-forming, each of the compacts can be released from the mold at a low release pressure without galling with the mold.

Hereinafter, the annealing step will be described. Each of the obtained compacts was put into a heating furnace and was heated for one hour in an atmosphere in which nitrogen gas flowed at a rate of 0.5 L/min. At this time, the heating temperature (annealing temperature) is shown in FIG. 5. As a result, various dust cores (samples) shown in FIG. 5 were obtained.

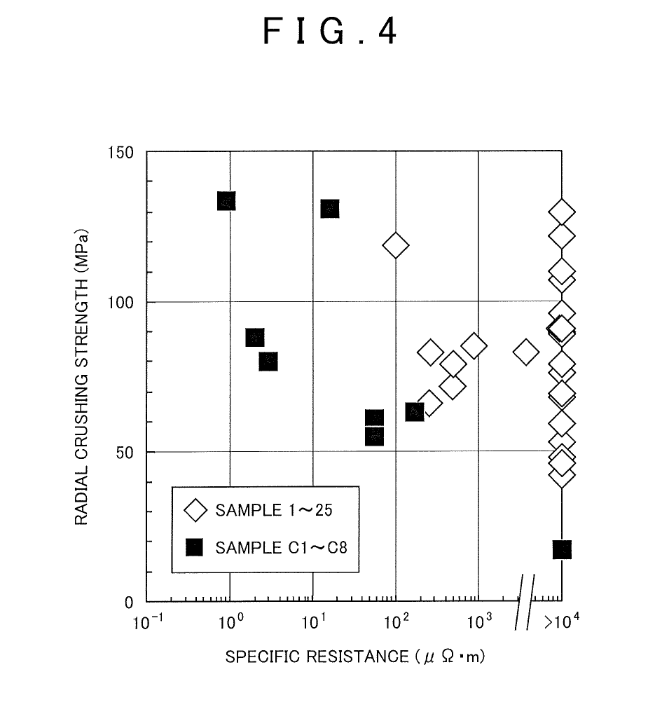

The specific resistance and radial crushing strength of each of the dust cores were obtained. The specific resistance was calculated based on electrical resistance and volume, in which the electrical resistance was measured with a four-terminal method using a digital multimeter, and the volume was actually measured from each of the samples. The radial crushing strength was measured using the annular sample according to JIS Z 2507. The results are shown in FIG. 5. A relationship between the specific resistance and the radial crushing strength of each of the samples is shown in FIG. 4. The term “≥10⁴” shown in the specific resistance item of FIG. 5 implies that the specific resistance of a measurement sample was higher than the measurement limit (over-range).

Hereinafter, a grain boundary structure will be described. As can be seen from the results of AES shown in FIG. 2, the first coating layer (Al—O layer) and the second coating layer (AlN layer) were formed in a grain boundary between soft magnetic powder particles after the nitriding step. The first coating layer and the second coating layer formed through the nitriding step were thermally and chemically stable. Therefore, it is considered that, in the dust cores of Samples 1 to 25 obtained through the glass attachment step, the press-forming step, and the annealing step, the third coating layer was formed to cover the second coating layer.

As clearly seen from FIGS. 4 and 5, it was found that all the dust cores including a grain boundary having the above-described three-layer structure exhibited sufficient specific resistance and radial crushing strength.

On the other hand, in Samples C1 to C3 in which the low-melting-point glass layer was formed and the AlN layer was not formed on a grain boundary, the specific resistance of the dust core was extremely low. Conversely, in Sample C4 in which the AlN was formed and the low-melting-point glass layer was not formed on a grain boundary, the specific resistance was high, but the radial crushing strength of the dust core was extremely low.

In addition, in the dust cores of Samples C5 to C7 in which the AlN layer was not formed and the Si—O layer or the Fe—O layer and the low-melting-point glass layer were formed on a grain boundary, the radial crushing strength was high, but the specific resistance was extremely low. The reason is presumed to be as follows: the Si—O layer or the Fe—O layer, with which the soft magnetic particles were coated, reacted with the molten (softened) low-melting-point glass to be modified during annealing, and the insulating properties thereof decreased.

Further, in the dust core of Sample C8 in which the AlN was not formed and the silicone resin layer and the low-melting-point glass layer were formed on a grain boundary, not only the specific resistance but also the radial crushing strength were low irrespective the presence of the low-melting-point glass layer. The reason is presumed to be as follows: the insulating properties were decreased by the silicone resin layer being heated to be modified during annealing; and small voids as fracture origins were formed on a grain boundary due to poor wettability of the molten (softened) low-melting-point glass on the silicone resin layer.

Based on the results, the following was clarified: in a dust core including a grain boundary having the three-layer structure of the first coating layer (Al—O layer), the second coating layer (AlN layer), and the third coating layer (low-melting-point glass layer), high specific resistance and high radial crushing strength are exhibited even after high-temperature annealing.

1-11. (canceled)

12: A method of producing powder for a magnetic core, the method comprising:
heating oxide particles comprising an oxide layer in a nitriding atmosphere at a temperature in a range of from 800° C. to 1050° C. to form a nitride layer made of aluminum nitride on at least a part of a surface of the oxide layer,
wherein the oxide particles Ar being made of an iron alloy comprising Al, and
the oxide layer is made of aluminum oxide, is disposed on at least a part of surfaces of the oxide particles, and is formed using gas-water atomized powder or water-atomized powder.

13: The method of claim 12, wherein
an oxygen concentration at the surfaces of the oxide particles is 0.08% or higher.

14: The method of claim 12, further comprising attaching a glass to at least a part of a surface of the nitride layer.

15: The method of claim 12, wherein the temperature is in a range of from 820° C. to 1000° C.

16: The method of claim 12, wherein the temperature is in a range of from 850° C. to 950° C.

17: The method of claim 12, wherein the aluminum oxide is an O-deficient aluminum oxide.

18: The method of claim 12, wherein the aluminum nitride is AlN.

19: The method of claim 12, wherein an Al content is 1 wt % to 5 wt % with respect to a total mass of the iron alloy.

20: The method of claim 12, wherein the iron alloy further comprises 0.4 wt % to 5 wt % Si with respect to a total mass of the iron alloy, and
a mass ratio of a content of Al to a total content of Al and Si in the iron alloy is 0.45 or higher.

21: A method of producing a dust core, the method comprising:
(i) heating oxide particles comprising an oxide layer in a nitriding atmosphere at a temperature in a range of from 800° C. to 1050° C. to form a nitride layer made of aluminum nitride on at least a part of a surface of the oxide layer, to obtain a powder,
wherein the oxide particles are made of an iron alloy comprising Al, and
the oxide layer is made of aluminum oxide, is disposed on at least a part of surfaces of the oxide particles, and is formed using gas-water atomized powder or water-atomized powder;
(ii) filling a mold with the powder;
(iii) press-forming the filled powder into a compact; and
(iv) annealing the compact.

22: The method of claim 20, further comprising attaching a glass to at least a part of a surface of the nitride layer.

23: The method of claim 20, wherein the temperature is in a range of from 820° C. to 1000° C.

24: The method of claim 20, wherein the temperature is in a range of from 850° C. to 950° C.

25: The method of claim 20, wherein the aluminum oxide is an O-deficient aluminum oxide.

26: The method of claim 20, wherein the aluminum nitride is AlN.

27: The method of claim 20, wherein an Al content is 1 wt % to 5 wt % with respect to a total mass of the iron alloy.

28: The method of claim 20, wherein the iron alloy further comprises 0.4 wt % to 5 wt % Si with respect to a total mass of the iron alloy, and
a mass ratio of a content of Al to a total content of Al and Si in the iron alloy is 0.45 or higher.
